(19) United States
(12) Patent Application Publication
(10) Pub. No.: US 2025/0377636 A1
(43) Pub. Date: Dec. 11, 2025

(54) TIMEPIECE COMPRISING A CHRONOGRAPH MECHANISM PROVIDED WITH A DEVICE INDICATING THE OPERATING STATUS OF THE CHRONOGRAPH MECHANISM

(71) Applicant: Omega SA, Biel/Bienne (CH)

(72) Inventors: Gregory KISSLING, La Neuveville (CH); Damien Clemencon, Orvin (CH); Théo Pennino, Nidau (CH)

(73) Assignee: Omega SA, Biel/Bienne (CH)

(21) Appl. No.: 19/043,825

(22) Filed: Feb. 3, 2025

(30) Foreign Application Priority Data
Jun. 5, 2024 (EP) 24180269.3

(51) Int. Cl. G04F 7/06

(52) U.S. Cl. CPC G04F 7/065

(57) ABSTRACT

A timepiece (1) including a horological movement (100) housed in a case, said horological movement (100) including a going train (5) dedicated to time division and a chronograph mechanism (200) including a chronograph train (230) configured to be coupled to the going train (5) on demand via a chronograph start/stop control device (210). The chronograph mechanism (200) includes a status indicator device (50) fixed to a coordination member (18) for rotation therewith, the status indicator device (50) including a first portion presenting a first item of information and a second portion presenting a second item of information, which is different from the first item of information, each portion of the status indicator (50) being positioned alternately facing an aperture in a mask comprised in the timepiece (1), each time the chronograph start/stop control device (210) is operated.

### CROSS REFERENCE TO RELATED APPLICATION

This application claims priority to European Patent Application No. 24180269.3 filed Jun. 5, 2024, the entire contents of which are incorporated herein by reference.

### TECHNICAL FIELD OF THE INVENTION

The present invention relates to a timepiece comprising a chronograph mechanism.

More particularly, the invention relates to a chronograph mechanism provided with a status indicator device for indicating, to the user, the status (running or stopped) of the chronograph mechanism.

### TECHNOLOGICAL BACKGROUND

Chronograph mechanisms allow time to be measured on demand by means of a plurality of chronograph counters, for example minute and seconds counters.

The chronograph mechanisms are activated, stopped and reset by control members, for example push-buttons, which may or may not be separate. Horological movements are also known to include a single push-piece allowing the chronograph mechanism to be started, stopped and allowing the various counters to be reset by being successively pressed multiple times.

It can be advantageous to provide the user with additional visual information about the status of the chronograph mechanism, whether it is running or stopped.

Patent document FR-866748 proposes in particular using a hand which is activated rotatably by turning a button.

Patent document CH-705439 also describes displaying the status of the chronograph mechanism using a hand facing a graduation on the dial, the hand being rigidly connected to a rotatable switch cooperating with and bearing against a three-position shuttle of a chronograph mechanism.

However, these solutions are not entirely satisfactory because they complicate the design, assembly and maintenance of horological movements.

There is therefore a need to improve horological movements provided with a chronograph mechanism.

### SUMMARY OF THE INVENTION

In this context, the invention proposes a timepiece comprising a horological movement housed in a case, said horological movement comprising a going train dedicated to time division and a chronograph mechanism comprising a chronograph train configured to be coupled to the going train on demand via a chronograph start/stop control device, the chronograph mechanism including a coordination member rotated about a pivot axis P2 each time the chronograph start/stop control device is operated and directly activating a set of control levers to provide the various operating statuses of the chronograph mechanism, characterised in that the chronograph mechanism comprises a status indicator device fixed to the coordination member for rotation therewith, the status indicator device comprising a first portion presenting a first item of information and a second portion presenting a second item of information, which is different from the first item of information, each portion of the status indicator being positioned alternately facing an aperture in a mask comprised in the timepiece, each time said chronograph start/stop control device is operated.

In addition to the features mentioned in the preceding paragraph, the timepiece according to the invention can have one or more complementary features from among the following, considered either on an individual basis or according to any combination technically possible:
the coordinating member is a chronograph cam;
said chronograph cam comprises at least one shuttle, the status indicator device being rigidly connected to said at least one shuttle;
the status indicator device is rigidly connected to said at least one shuttle by being driven therein or screwed thereon;
the status indicator device is rigidly connected to said at least one shuttle, at a distance from the pivot axis P2 of the chronograph cam, by being driven therein or screwed thereon;
the status indicator device is formed integrally in one piece with said at least one shuttle;
said case comprises a crystal and in that the mask is interposed between the horological movement and the crystal in order to view the status indicator device through the aperture on the dial side of the horological movement;
the timepiece comprises a dial fastened above the horological movement, said mask being a layer applied to the dial or being formed by the dial;
said case comprises a transparent back and in that the mask is interposed between the horological movement and the transparent back in order to view the status indicator device through the aperture on the back side of the horological movement;
the mask is a layer applied to the inside face of the transparent back;
the mask is an ink applied by digital printing on the inside face of the transparent back.

### BRIEF DESCRIPTION OF THE FIGURES

The purposes, advantages and features of the present invention will be better understood upon reading the detailed description given below with reference to the following figures:

FIG. 1 diagrammatically shows a bottom view of a horological movement according to the invention, which movement comprises a chronograph mechanism; more particularly, FIG. 1 illustrates the chronograph mechanism stopped;

FIG. 2 diagrammatically shows a bottom view of the horological movement illustrated in FIG. 1 when the chronograph mechanism is running;

FIG. 3 diagrammatically shows a perspective view illustrating in particular a chronograph cam of the chronograph mechanism comprising a status indicator device according to the invention;

FIG. 4 diagrammatically shows the timepiece from the back when the chronograph mechanism is stopped;

FIG. 5 diagrammatically shows the timepiece from the back when the chronograph mechanism is running;

FIG. 6 diagrammatically shows a timepiece according to the invention, which timepiece comprises a chronograph mechanism and a device for indicating the operating status of the chronograph mechanism.

In all the figures, common elements bear the same reference numerals unless specified to the contrary.

### DETAILED DESCRIPTION OF THE INVENTION

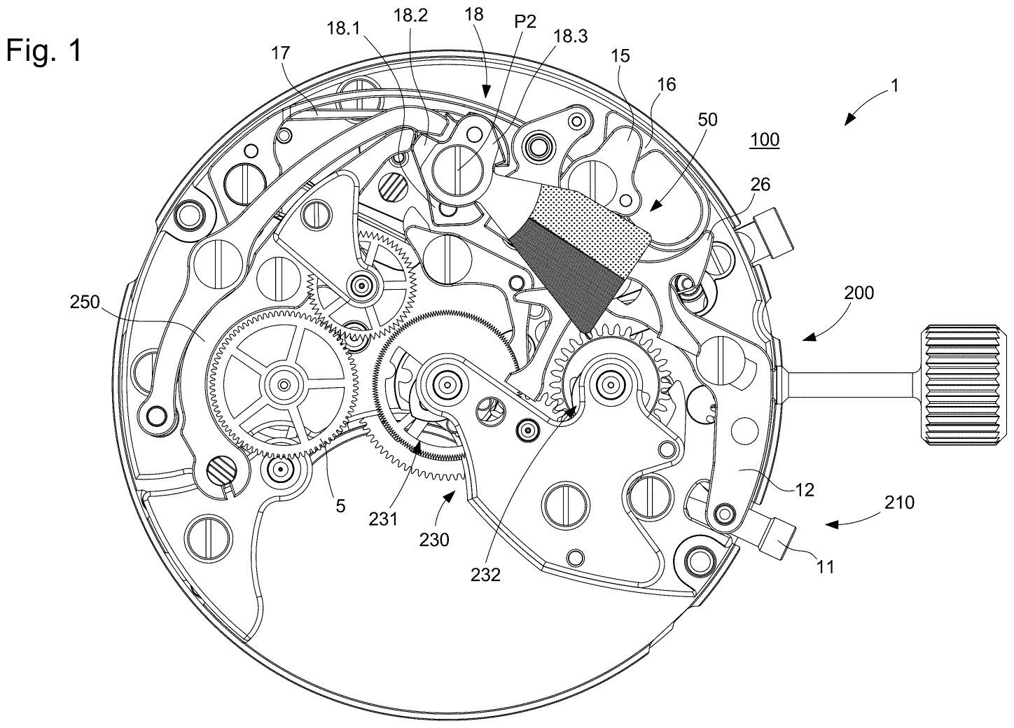

FIG. 1 diagrammatically shows a bottom view of a horological movement 100 of a timepiece 1 according to the invention, which movement comprises a chronograph mechanism 200. More particularly, FIG. 1 shows the chronograph mechanism 200 when stopped.

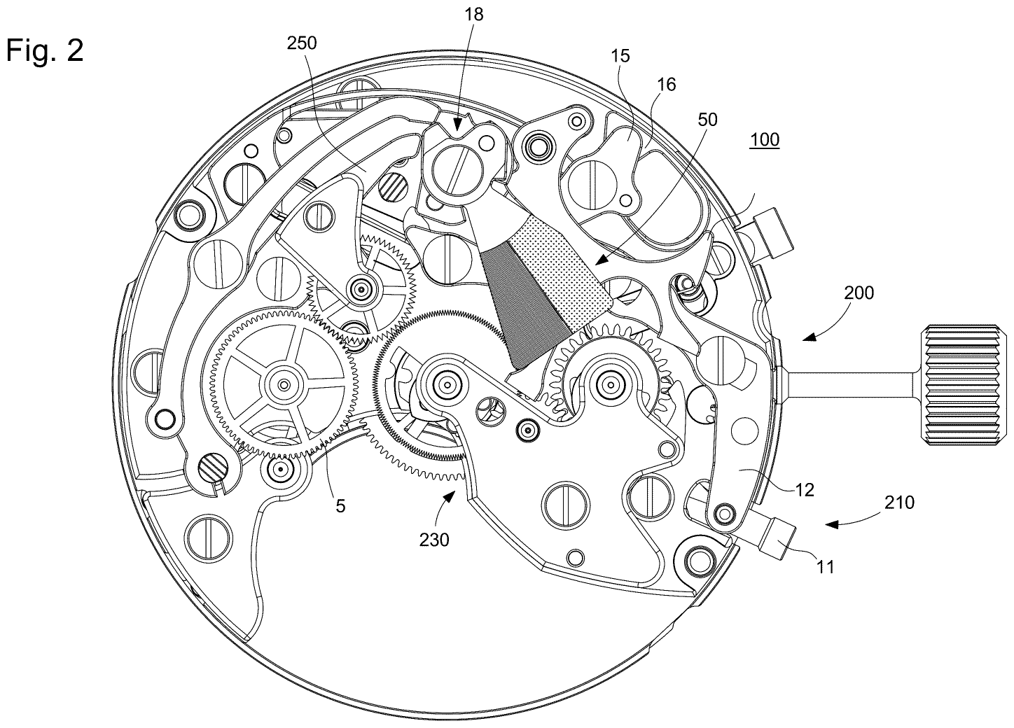

FIG. 2 diagrammatically shows a bottom view of the horological movement 100 comprising a chronograph mechanism 200 according to the invention, when the chronograph mechanism 200 is running.

In the example embodiment shown in the various figures of the present application, the chronograph mechanism 200 is a cam-operated chronograph mechanism. However, the invention can also be applied with a chronograph mechanism having a column wheel while still remaining within the scope of the invention.

Conventionally, the horological movement 100 according to the invention includes a running train 5 (shown in part) dedicated to time division, and driven by an energy source (not shown).

The chronograph mechanism 200 comprises a chronograph train 230 driven on demand via the going train 5. Conventionally, the chronograph train 230 comprises at least one chronograph minute counter 232 and one chronograph seconds counter 231.

The chronograph mechanism 200 comprises a coupling lever 250 configured to couple and uncouple, on demand, the chronograph train 230 from the going train 5 of the horological movement 100.

Thus, the coupling lever 250 allows the chronograph train 230 to be kinematically connected to the going train 5 on demand via a chronograph start/stop control device 210, so that the going train is driven in time with the regulating member of the going train 5.

The chronograph start/stop control device 210 comprises a start/stop push-piece 11 kinematically connected to a control 12. In the example embodiment shown, the push-piece 11 is rigidly connected to the control 12 and the assembly moves translatably under the action of the push-piece 11.

According to one alternative embodiment, the control 12 is of the lever type and pivots about a pivot axis under the effect of the push-piece 11.

The control 12 can in turn drive an intermediate control (not shown) which rotates a control lever 15. The control lever 15 is under the effect of a control spring 16 which returns the control lever 15, the control 12 and the intermediate control to the rest position when the push-piece 11 is no longer activated by the user.

The intermediate control comprises an end portion cooperating with a coordination member 18 directly activating a set of control levers to provide the various functions and statuses of the chronograph mechanism 200.

The coordination member 18 is movable about a pivot axis P2 and is rotated each time the chronograph start/stop control device 210 is operated. Such a coordination member makes it possible to coordinate the various phases of the chronograph mechanism 200 and to control the various levers or rockers of the chronograph mechanism 200 to provide these various phases: running, stopped and reset. As is well known, the various levers or rockers activated by the coordination member 18 are in particular a coupling lever, a hammer and a stopper.

In the example embodiment shown, the coordination member is a chronograph cam 18.

Another known coordination member for a chronograph mechanism is a column wheel.

The chronograph cam 18 has a lower shuttle 18.1 cooperating with the end portion of the intermediate control.

The end portion of the intermediate control is configured to rotate the lower shuttle 18.1 by at least one notch, about its pivot axis P2, each time the push-piece 11 is operated, clockwise or counter-clockwise depending on the position of the lower shuttle 18.1.

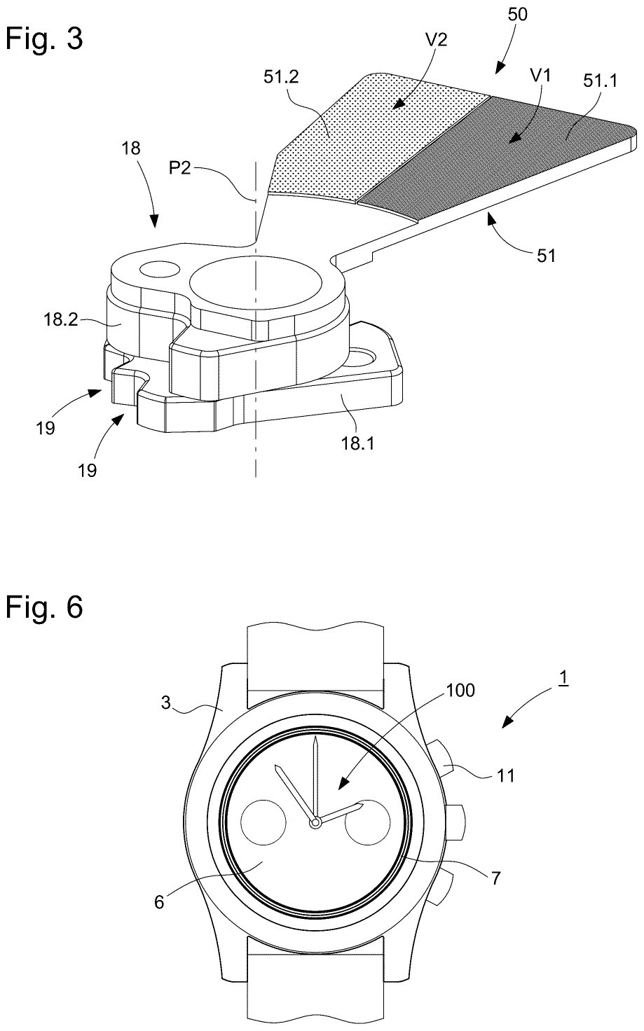

The lower shuttle 18.1 cooperates with a shuttle spring 17 which locks each change of position of the lower shuttle 18.1 by engaging in one of the notches 19 in the lower shuttle 18.1 provided for this purpose. In the example embodiment shown, particularly in FIG. 3, the lower shuttle 18.1 has two notches 19 configured to cooperate with the shuttle spring 17, so as to index two stable positions of the chronograph cam 18.

The chronograph cam 18 comprises the lower shuttle 18.1, described above, which is fixed to an upper shuttle 18.2 for rotation therewith, which cooperates in particular with a reset hammer 26 for resetting the chronograph counters 231, 232.

The coupling lever 250 cooperates by bearing against the lower shuttle 18.1 of the chronograph cam 18, so that a change in the angular position of the lower shuttle 18.1 modifies the position and status of the coupling lever 250 by passing from a status in which it is engaged with the chronograph train 230 to a status in which it is disengaged from the chronograph train 230 and vice-versa.

The chronograph mechanism 200 comprises a status indicator device 50 having at least two statuses and set in motion each time the chronograph start/stop control device 210 is operated. The status indicator device 50 provides the user with additional information, for example by means of a colour code, corresponding to the operating status of the chronograph mechanism 200, i.e. whether it is running or stopped.

The status indicator device 50 comprises two different visual displays which are positioned alternately facing an aperture 25 in a mask 30 comprised in the timepiece 1.

Thus, the user can easily view the operating status of the chronograph mechanism 200, either on the dial side or on the back side of the timepiece 1, through an opening provided for this purpose.

The status indicator device 50 is rigidly connected to the coordination member 18.

In the example embodiment shown, the status indicator device 50 is rigidly connected to the chronograph cam 18.

For example, the status indicator device 50 is rigidly connected to one of the shuttles 18.1, 18.2 of the chronograph cam 18 by being driven therein or screwed thereon.

Preferably, the status indicator device 50 is rigidly connected to one of the shuttles 18.1, 18.2 at a distance from the pivot axis P2 of the chronograph cam 18 by being driven therein or screwed thereon.

For example, the status indicator device 50 is formed integrally in one piece with the chronograph cam 18 or with one of the shuttles 18.1, 18.2 of the chronograph cam 18.

According to the example embodiment shown, the status indicator device 50 takes the shape of a plate 51 rigidly connected to the chronograph cam 18.

FIG. 3 illustrates in particular the chronograph cam 18 carrying the plate 51. For example, as illustrated, the plate 51 is fixed to the upper shuttle 18.2 for rotation therewith. However, the plate 51 can also be rigidly connected to the lower shuttle 18.1.

The plate 51 has two portions 51.1, 51.2 extending radially relative to the pivot axis P2 of the chronograph cam 18, each portion 51.1, 51.2 having respectively a first item of information V1 and a second item of information V2 which are specific and different from one another, for example two different colours or two different patterns. Each item of information V1, V2 is associated with an operating status of the chronograph mechanism 200.

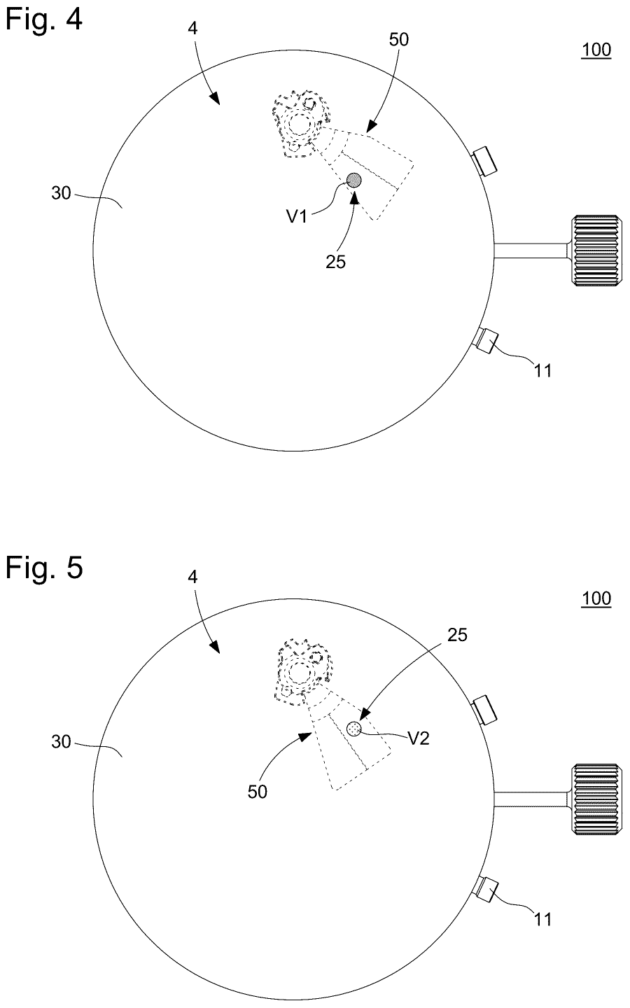

The plate 51 is positioned facing at least one aperture 25 (two apertures are shown in FIGS. 4 and 5 by way of example), formed by an opening or a transparent portion of a mask 30, so that only a limited portion of the plate 51 can be seen. Thus, depending on the angular position of the plate 51, the first portion 51.1 or the second portion 51.2 of the plate 51 is visible through the aperture 25.

The mask 30 is interposed between the horological movement 100 and the crystal of the case 3 or between the horological movement and a transparent back 4.

The mask 30 can be arranged on the dial 6 of the timepiece, on the inside face of the crystal or on the inside face of the transparent back 4.

Alternatively, the mask is formed by the dial of the timepiece, the dial comprising an opening or a transparent portion to form the aperture 25, allowing the portions 51.1, 51.2 of the plate 51 positioned under the dial to be viewed alternately through the crystal of the timepiece.

Preferably, the mask 30 is formed by an opaque layer deposited on an inner face of a transparent back.

For example, the layer forming the mask 30 is an ink deposited, for example, by digital printing. For example, the layer can represent a pattern.

FIGS. 4 and 5 diagrammatically illustrate the horological mechanism 100 from below through the mask 30, allowing the plate 51 of the status indicator device 50 (shown in dotted lines) and the operating status of the chronograph mechanism 200 to be viewed through the aperture 25 in the mask 30. In FIGS. 4 and 5, the case, middle and back of the timepiece are not shown.

Thus, depending on the angular position of the chronograph cam 18 relative to its pivot axis P2, the user can view through the aperture 25 the first portion 51.1 comprising the first item of information V1 and corresponding to a first status of the chronograph mechanism 200, for example stopped, or the second portion 51.2 comprising the second item of information V2 which corresponds to a second status of the chronograph mechanism 200, for example running.

This additional information on the operating status of the chronograph mechanism 200 is provided without complicating the horological movement 100.

Thanks to the invention, the chronograph mechanism is simplified and easier to adjust and implement, in particular because it does not include additional movable parts that complicate the chronograph mechanism and the horological movement. More specifically, the use of different movable parts to achieve such a function requires multiplying the operating clearances, which leads to inaccuracy at the end of the kinematic chain and difficulties in correctly adjusting the position of the status indicator.

Thanks to the invention, this additional visual information is provided by a simple additional plate rigidly connected to the chronograph cam or rigidly connected to a shuttle of the chronograph cam. In particular, such an architecture makes it possible to improve the positioning accuracy of the status indicator by eliminating the operating clearances inherent in the installation of different movable parts interacting with each other.

More generally, the status indicator device 50 can be an attachment rigidly connected to the chronograph cam 18, the coupling lever 250 or by another part of the chronograph mechanism 200 having two different and alternating stable positions depending on the operating status of the chronograph mechanism 200.

The status indicator device 50 can be made in one piece with the chronograph cam, the coupling lever 250 or another part of the chronograph mechanism 200 having two different and alternating stable positions depending on the operating status of the chronograph mechanism 200.

According to an alternative embodiment in which the chronograph mechanism comprises a column wheel and not a chronograph cam, the status indicator device 50 can also be carried by the column wheel. In this case, the status indicator device 50 comprises a plurality of first portions 51.1 and a plurality of second portions 51.2 which are alternated so as to alternately display a first portion 51.1 and then a second portion 51.2 of the status indicator device 50 each time the chronograph start/stop control device 210 is operated.

The invention further relates to a timepiece 1, for example a wristwatch, comprising such a horological movement 100. Such a timepiece 1 is illustrated diagrammatically with reference to FIG. 6. The timepiece 1 comprises a case 3 in which a horological movement 100 according to the invention is cased.

Preferably, the timepiece 1 comprises a crystal 7 and a transparent back 4 closing the rear of the case 3. The transparent back 4 has a mounting ring and a transparent central portion, for example made of sapphire.

Preferably, a mask 30 is applied to the inside face of the transparent central portion of the transparent back 4. The mask 30 comprises an opening forming an aperture 25 allowing the status indicator device 50 indicating the operating status of the chronograph on the back side of the horological movement 100 to be viewed through the mask 30.

According to one alternative embodiment, the mask 30 is an additional layer applied to the dial 6 to view the status indicator device 50 indicating the operating status of the chronograph on the dial side of the horological movement 100.

In one alternative embodiment, the mask 30 is formed by the dial 6, which has an opening to allow the status indicator device 50 to be viewed through the dial.

### Operation of the Chronograph Mechanism According to the Invention

When the chronograph mechanism 200 is stopped, for example after a reset, the chronograph cam 18 is immobilised in a first angular position, referred to as the stop position, by the shuttle spring 17 which cooperates with a first notch 19 in the lower shuttle 18.1. In this position of the chronograph cam 18, the coupling lever 250 is uncoupled from the chronograph train 230. This stop position of the chronograph mechanism is illustrated more particularly in FIG. 1 and FIG. 4.

In this stop position, the first portion 51.1 of the plate 51 faces the aperture 25 in the mask 30. In this first position, the user can see the first item of information V1 corresponding to the first portion 51.1 through this aperture 25, indicating that the chronograph mechanism is stopped, as illustrated in FIG. 4.

When the push-piece 11 is pushed for the first time, the push-piece 11 moves the control 12, the intermediate control, if present, and the control lever 15 against the force exerted by the control spring 16. The lower shuttle 18.1 is then moved one notch clockwise, according to the example embodiment shown, and held in position by the shuttle spring 17 cooperating with a second notch 19 in the lower shuttle 18.1, and thus the push-piece can be released.

The change in position of the chronograph cam 18 modifies the position of the lower shuttle 18.1 which allows the coupling lever 250 to pivot under the effect of a lever spring so as to couple the going train 5 to the chronograph train 230.

The change in position of the chronograph cam 18 also modifies the position of the plate 51 which is fixed to the upper shuttle 18.2 for rotation therewith, so that henceforth the second portion 52.2 presenting the second item of information V2 of the plate 51 is facing the aperture 25 in the mask 30. In this second position, the user can see a second item of information through this aperture 25, indicating that the chronograph mechanism is running, as illustrated in FIG. 5.

By pushing the push-piece 11 again, the push-piece 11 again moves the control 12, the intermediate control and the control lever 15 against the force exerted by the control spring 16. The lower shuttle 18.1 is then moved counter-clockwise by one notch, according to the example embodiment shown, and held in position by the shuttle spring 17 cooperating with the first notch 19 of the corresponding lower shuttle 18.1, and thus the push-piece can be released.

The change in position of the chronograph cam 18 modifies the position of the lower shuttle 18.1, which uncouples the coupling lever 250 10 from the chronograph train 230 and repositions the first portion 51.1 of the plate 51 to face the aperture 25.

1. A timepiece comprising a horological movement housed in a case, said horological movement comprising a going train dedicated to time division and a chronograph mechanism comprising a chronograph train configured to be coupled to the going train on demand via a chronograph start/stop control device, the chronograph mechanism including a coordination member rotated about a pivot axis each time the chronograph start/stop control device is operated and directly activating a set of control levers to provide the various operating statuses of the chronograph mechanism, wherein the chronograph mechanism comprises a status indicator device fixed to the coordination member for rotation therewith, the status indicator device comprising a first portion presenting a first item of information and a second portion presenting a second item of information, which is different from the first item of information, each portion of the status indicator being positioned alternately facing an aperture in a mask comprised in the timepiece, each time said chronograph start/stop control device is operated.

2. The timepiece according to claim 1, wherein the coordinating member is a chronograph cam.

3. The timepiece according to claim 2, wherein said chronograph cam comprises at least one shuttle, the status indicator device being rigidly connected to said at least one shuttle.

4. The timepiece according to claim 3, wherein the status indicator device is rigidly connected to said at least one shuttle by being driven therein or screwed thereon.

5. The timepiece according to claim 4, wherein the status indicator device is rigidly connected to said at least one shuttle, at a distance from the pivot axis of the chronograph cam, by being driven therein or screwed thereon.

6. The timepiece according to claim 1, wherein the status indicator device is formed integrally in one piece with said at least one shuttle.

7. The timepiece according to claim 1, wherein said case comprises a crystal and in that the mask is interposed between the horological movement and the crystal in order to view the status indicator device through the aperture on the dial side of the horological movement.

8. The timepiece according to claim 7, wherein the timepiece comprises a dial fastened above the horological movement, said mask being a layer applied to the dial or being formed by the dial.

9. The timepiece according to claim 1, wherein said case comprises a transparent back and in that the mask is interposed between the horological movement and the transparent back in order to view the status indicator device through the aperture on the back side of the horological movement.

10. The timepiece according to claim 9, wherein the mask is a layer applied to the inside face of the transparent back.

11. The timepiece according to claim 10, wherein the mask is an ink applied by digital printing on the inside face of the transparent back.
